(19) United States
(12) Patent Application Publication
(10) Pub. No.: US 2012/0196480 A1
(43) Pub. Date: Aug. 2, 2012

(54) ELECTRICAL CONNECTION ELEMENT, ELECTRICAL CONNECTOR AND METHOD FOR MANUFACTURING THE SAME

(75) Inventor: Jian Hua Hu, ShenZhen (CN)

(73) Assignee: International Business Machines Corporation, Armonk, NY (US)

(21) Appl. No.: 13/204,087

(22) Filed: Aug. 5, 2011

(30) Foreign Application Priority Data
Aug. 6, 2010 (CN) 201010251968.3

(51) Int. Cl. H01R 13/40; H01R 43/04; H01R 13/03

(52) U.S. Cl. 439/625; 439/887; 29/882

(57) ABSTRACT

The invention provides an electrical connection element made up of a metal wire that is an ellipse as a whole, two end portions of one axis of the ellipse forming an upper contact part and a lower contact part respectively, at least one retention part being formed at the middle part between the upper contact part and the lower contact part, the retention part being wider than other positions of the electrical connection element in at least one dimension. The invention also provides an electrical connector comprising: the above electrical connection element and a housing having at least one slot, wherein the upper contact part of each electrical connection element extends above the upper surface of the housing, the lower contact part of each electrical connection element extends below the lower surface of the housing, and the at least one retention part is embedded in the at least one slot. The above electrical connection element and electrical connector can provide stable connection performance. The invention also provides a method for manufacturing the electrical connection element and the electrical connector, which is simple and easy to implement and is adapted for mass production.

### TECHNICAL FIELD

The present invention relates to an electrical connection element and an electrical connector, and more particularly, to a contact array type electrical connection element, an electrical connector and method for manufacturing the same.

### DESCRIPTION OF THE RELATED ART

In a computing system such as a computer, various hardware components need to be connected to a mainboard via connection interfaces or electrical connectors so as to perform calculation, operation and communication. For example, after many years' development, a variety of connection interfaces such as lead type, card type, pin type, contact type etc. have been adopted between processor (CPU) and mainboard.

Pin type connection is a widely used connection manner between CPU and mainboard. Under such connection manner, several pins are disposed on CPU, and corresponding electrical connectors (or referred to as sockets) are provided on the mainboard, which have plug-holes for receiving the pins and electrically connected thereto. However, since pins on the CPU are prone to be broken off or bent, thereby affecting the connection to mainboard, pin type interface has been more and more replaced by contact type interface.

For contact type connection, a plurality of contacts are formed on an electrical connector. These contacts constitute an array and form electrical connections with CPU and mainboard respectively. Therefore, such electrical connector is also referred to as Land Grid Array (LGA) electrical connector. A typical LGA electrical connector includes a plurality of electrical connection elements, each of which is made of a metal plate and thus forms one contact on each of the upper and lower surface of the housing of the electrical connector, respectively.

FIGS. 1A and 1B show a diagram of an electrical connection element of a LGA electrical connector. As shown, the electrical connection element 10 is made by a whole sheet of metal plate and forms the shape as shown through punching. The electrical connection element may be divided into three parts according to its shape, that is, upper contact part 10T, middle part 10M and lower contact part 10B, wherein the middle part 10M is embedded within the housing of the electrical connector, the upper contact part 10T extends above the upper surface of the housing of the electrical connector, thus forming a contact interface with CPU, and the lower contact part 10B extends below the lower surface of the housing of the electrical connector, thus forming a contact interface with the mainboard. The upper and lower contact interface areas are substantially parallel to the upper and lower surface of the housing of the electrical connector. It can be seen that, to form such upper and lower contact part, a tabular metal plate needs to be bent and shaped as the shape shown, which will inevitably form multiple bended edges in the electrical connection element. Such bended edges are especially intensively formed at the upper and lower contact part 10T and 10B, as more clearly shown in FIG. 1B. Due to limitation in punch process of metal plate, it is hard to control uniformity and smoothness of the above edge area, and the process of punching will cause great damage to metal material of the edge area, especially at shear surface and tear surface. Thus, during usage of the electrical connector, the sharp edge area is prone to be oxidized or eroded. Subsequently, oxidation or erosion will extend from such edge area to active contact area 11, thereby affecting connection performance of the whole electrical connection element. Therefore, it is desirable to improve the existing electrical connector, thereby increasing its stability and connection performance.

### SUMMARY OF THE INVENTION

The invention is proposed in view of the defects in the existing electrical connector and is intended to provide an improved electrical connection element, an electrical connector and a method for manufacturing the same.

An embodiment according to a first aspect of the invention provides an electrical connection element made up of a metal wire that is an ellipse as a whole, two end portions of one axis of the ellipse forming an upper contact part and a lower contact part respectively, at least one retention part being formed at the middle part between the upper contact part and the lower contact part, the retention part being wider than other positions of the electrical connection element in at least one dimension.

An embodiment according to a second aspect of the invention provides an electrical connector comprising: a housing having at least one slot therein; at least one electrical connection element according to the first aspect disposed in the at least one slot, wherein the upper contact part of each electrical connection element extends above the upper surface of the housing, and the lower contact part of each electrical connection element extends below the lower surface of the housing, and the at least one retention part is embedded in the at least one slot.

An embodiment according to a third aspect of the invention provides a method for manufacturing an electrical connection element, comprising: forming at least one retention part on a metal wire, the metal wire where the retention part locates being wider than other positions in at least one dimension; and shaping the metal wire into an ellipse as a whole to be used as an electrical connection element, two end portions of one axis of the ellipse forming an upper contact part and a lower contact part respectively.

An embodiment according to a fourth aspect of the invention provides a method for manufacturing an electrical connector, comprising: manufacturing an electrical connection element according to the third aspect; and inserting at least one electrical connection element into at least one slot of a housing, such that the upper contact part of each electrical connection element extends above the upper surface of the housing, the lower contact part of each electrical connection element extends below the lower surface of the housing, and the at least one retention part is embedded in the at least one slot.

The electrical connection element of the embodiments of the invention and the electrical connector formed therefrom has stable connection performance, which makes connection of hardware modules in a computing system more reliable; in addition, the method for manufacturing the electrical connection element and the electrical connector of the embodiments of the invention is simple and easy to operate, which is beneficial to mass manufacture and production of the proposed electrical connector.

### BRIEF DESCRIPTION OF THE DRAWINGS

FIGS. 1A and 1B show a diagram of an electrical connection element of a LGA electrical connector;

FIG. 2 shows a diagram of an electrical connection element according to an embodiment of the invention;

FIG. 3 shows a diagram of a retention part in the electrical connection element according to an embodiment of the invention;

FIGS. 4A, 4B, 4C show a top view, a bottom view and a side view of an electrical connector according to an embodiment of the invention, respectively;

FIG. 4D shows a sectional view of the connection of the electrical connector according to an embodiment of the invention with other components;

FIG. 5 shows a process flowchart of manufacturing an electrical connector according to an embodiment of the invention;

FIG. 6 shows a process of acquiring metal wire according to an embodiment of the invention;

FIG. 7 shows a process of forming retention parts according to an embodiment of the invention;

FIG. 8A shows a process of shaping a metal wire according to an embodiment of the invention;

FIG. 8B shows a process of shaping multiple metal wires according to an embodiment of the invention;

FIG. 9 shows the interaction of a slot of the electrical connector with a retention part according to an embodiment of the invention;

FIG. 10A shows a process of forming V-cuts according to an embodiment of the invention;

FIG. 10B shows the V-cuts formed according to the process of FIG. 10A; and

FIGS. 11A and 11B show a process of inserting electrical connection elements into slots and breaking the metal wires according to an embodiment of the invention.

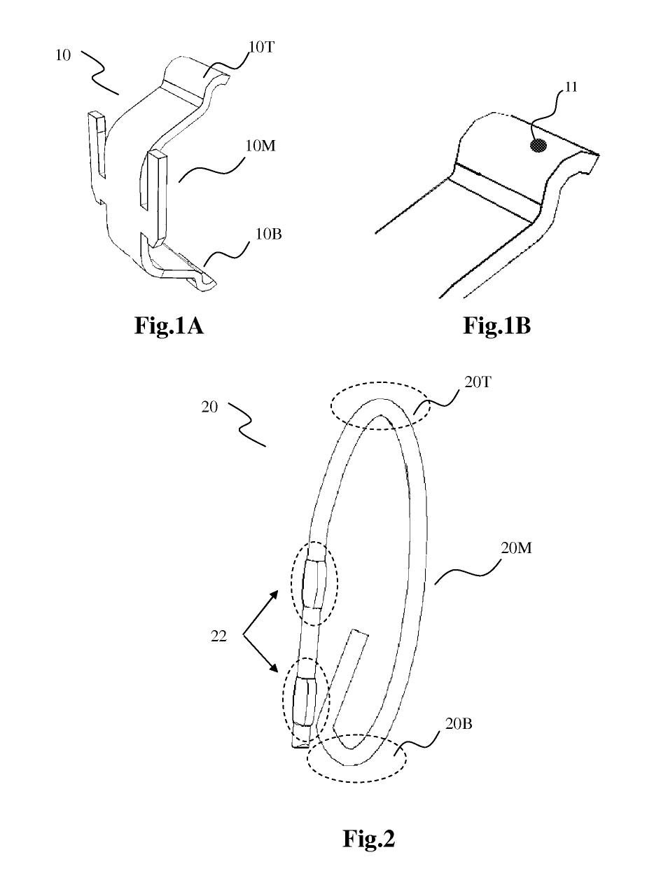

### DETAILED DESCRIPTION OF THE PREFERRED EMBODIMENT

Detailed embodiments of the invention will be described below with reference to accompany drawings.

FIG. 2 shows a diagram of an electrical connection element according to an embodiment of the invention. The electrical connection element is generally denoted as 20 in FIG. 2. As shown, the electrical connection element 20 is made up of a metal wire, which is bent as smooth curve. In the depicted embodiment, one electrical connection element is formed by a single metal wire. In other embodiments, the electrical connection element may also be formed by a bundle of metal wires. In the depicted embodiment, the electrical connection element is generally presented as an ellipse or in the shape of Q.

In one embodiment of the invention, the metal wire forming the electrical connection element 20 has smooth surface. In a specific example, cross section of the metal wire is a circle or ellipse, for example. In another hand, in one embodiment, the metal wire has good elasticity so as to provide sufficient normal force during elastic deformation. In another embodiment, the metal wire has high hardness and strength to bear large pressure. In addition, as an electrical connection element, the metal wire needs to have good electrical conductivity. In a specific example, the metal wire is copper alloy. Further, to make the electrical connection element better resist oxidization and erosion, in one embodiment, surface of the metal wire is coated with a stable coating, such as plating gold over nickel underplating on surface of copper alloy. It is appreciated that, those skilled in the art can choose appropriate metal material according to requirement on connection nature of the electrical connection element.

Based on shape of the metal wire shown in FIG. 2, the electrical connection element 20 may be divided into three parts, that is, upper contact part 20T, lower contact part 20B and middle part 20M, wherein the upper and lower parts 20T, 20B are made up by portions near two end points of the long axis of the ellipse formed by the electrical connection element 20 respectively, and the middle part 20M is located between the upper and lower parts 20T, 20B. It is appreciated that, for said elliptic electrical connection element, the long axis and the short axis of the ellipse may also be equal, so that it is specialized as a circle. In this case, the upper and lower contact parts may be made up by portions at both ends of a diameter of the circle.

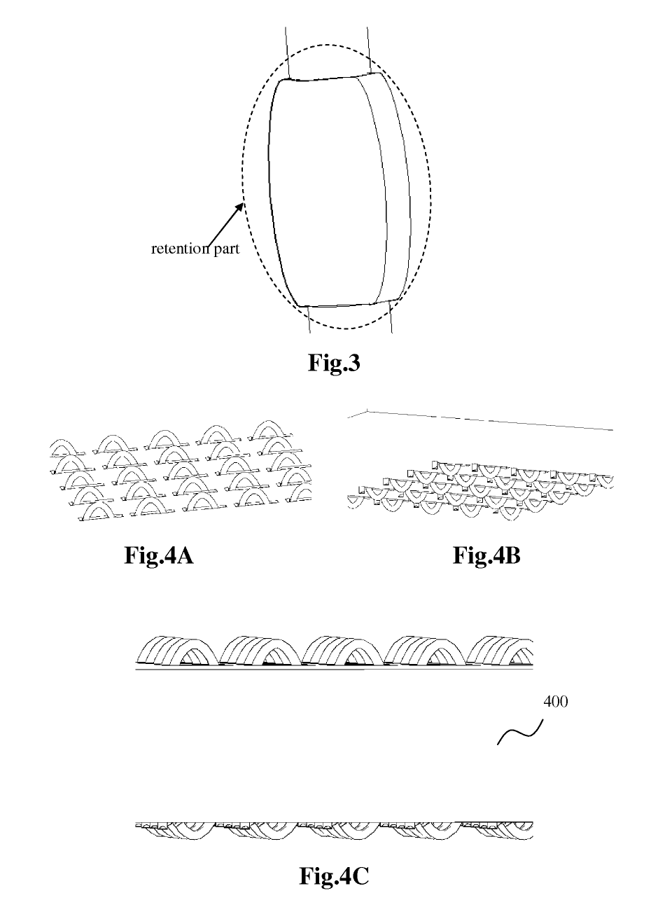

In one embodiment, retention parts 22 are formed in middle part 20M area of the electrical connection element 20. FIG. 3 shows a diagram of a retention part in the electrical connection element according to an embodiment of the invention. As shown, the retention part 22 may be formed by planishing local metal wire of the middle part 20M, such that the metal wire of retention part 22 is wider than other positions in one dimension. In case that cross section of the metal wire is a circle, it can be considered that width of metal wire is the diameter of the above circular cross section in most portion of the electrical connection element 20. By planishing the circular metal wire, the metal wire at retention part 22 becomes flat, the width of which is larger than the above diameter in one dimension (e.g., in a direction perpendicular to the plane of the ellipse) while smaller than the above diameter in other dimensions.

In another embodiment, the retention part 22 may be formed in other ways. For example, the metal wire forming the electrical connection element may have a knot-like bulge at the retention part, such that it has a width larger than other positions.

The functions of retention part include, after the electrical connection element 20 has been mounted to housing of the electrical connector, due to the effect of width difference of the retention part, it interacts with the housing, so that the electrical connection element 20 is fixed to corresponding position in the housing. In the example shown in FIG. 2, the retention parts 22 are located at one side of the middle part 20M. Therefore, when the electrical connection element 20 is installed in position, it is fixed to the housing only at the side where the retention parts 22 are located, thus forming a single cantilever structure. Accordingly, both the upper contact part 20T and the lower contact part 20B are located at free end of that single cantilever. Such a structure is very beneficial for the electrical connection element 20 to generate elastic deformation freely so as to be in contact with CPU and mainboard.

Although in the example of FIG. 2, the middle part 20M includes two retention parts 22, it is appreciated that, based on the desired size of the electrical connection element, only one retention part may be set or more than two retention parts may be set, and it (they) can be set at proper position in the middle part 20M as needed.

In one embodiment, tail end of the metal wire forming the electrical connection element 20 is formed by breaking the metal wire along V-cuts, so as to facilitate simpleness and operability of electrical connection element manufacture process. In other embodiments, tail end of the metal wire may also be formed via other manners such as cut off directly, thereby presenting different shapes.

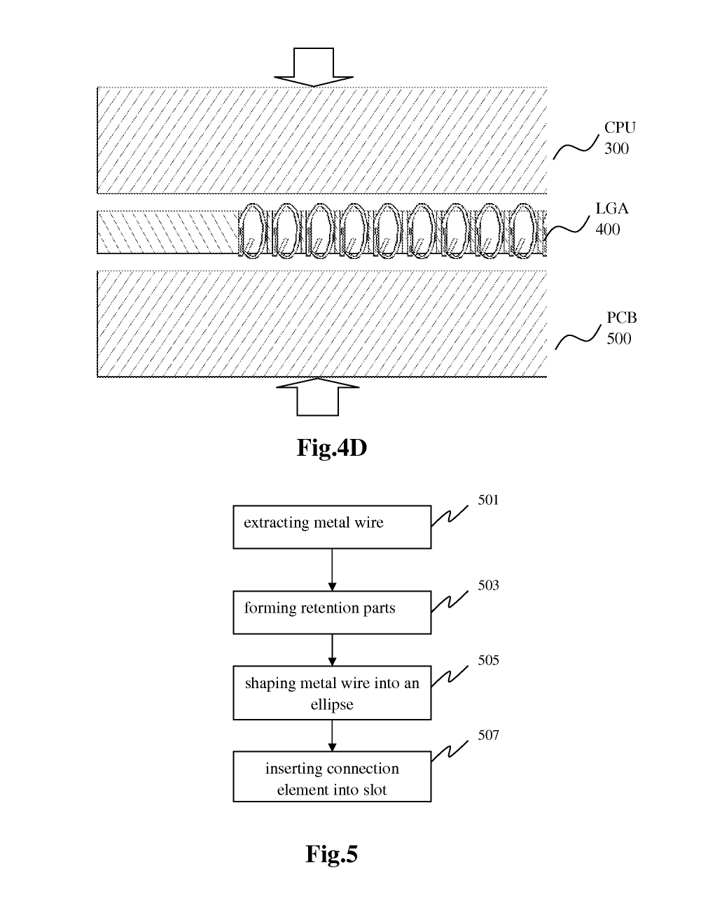

If simply fixing multiple electrical connection elements shown in FIG. 2 into a housing, a contact type electrical connector may be formed. FIG. 4A, 4B, 4C show a top view, a bottom view and a side view of an electrical connector according to an embodiment of the invention, respectively. As shown in FIG. 4A-4C, the housing of electrical connector 400 has a plurality of slots therein, each of which receives and fixes one electrical connection element, such that these electrical connection elements corresponding to the slots are arranged as an array in the housing of the electrical connector accordingly. Each electrical connection element is fixed in a slot of the housing via its retention parts, with the upper contact part thereof extending above the upper surface of the housing (FIG. 4A), the lower contact part thereof extending below the lower surface of the housing (FIG. 4B).

FIG. 4D shows the connection of the electrical connector according to an embodiment of the invention with other components. As shown, during operation, the electrical connector 400 is disposed between CPU module 300 and mainboard 500. At this time, corresponding contacts of the CPU module will be in contact with the upper contact parts of electrical connection elements exposed outside of the upper surface of the electrical connector 400, and contacts on the mainboard will be in contact with the lower contact parts of electrical connection elements extending below the lower surface of the electrical connector 400. In order for the CPU module to be fixed to the mainboard firmly, a downward pressure will be applied on the CPU module. As the pressure increases, electrical connection elements in the electrical connector 400 will generate elastic deformation. Such elastic deformation makes the upper and lower contact parts of electrical connection elements present upward and downward normal forces respectively, so that the electrical connection elements will be in tight and firm contact with the CPU module and the mainboard. As such, the CPU module and the mainboard form electrical connections via electrical connection elements in the electrical connector. Further, via the electrical connections, the CPU module and the mainboard can pass current and various signals to each other so as to realize communication.

Although connection manner of the electrical connector has been described in conjunction with connection of CPU module and mainboard, it is appreciated that, the above described electrical connector is not only limited to connection between CPU module and mainboard, but applicable to connection between any two appropriate hardwares in a computing system as needed.

As mentioned above, the electrical connector of the embodiment of the invention can connect various hardware modules together through smooth and elastic electrical connection elements. Since the electrical connection elements are made up by bended smooth metal wires, there is no sharp edge in each electrical connection element, thereby avoiding oxidization and erosion in metal of the electrical connection element. Furthermore, the elliptic shape formed by the electrical connection element is easy to generate elastic deformation and create normal force, which is advantageous in forming firm contact connection. In addition to the above features, the described electrical connector is also easy to be manufactured.

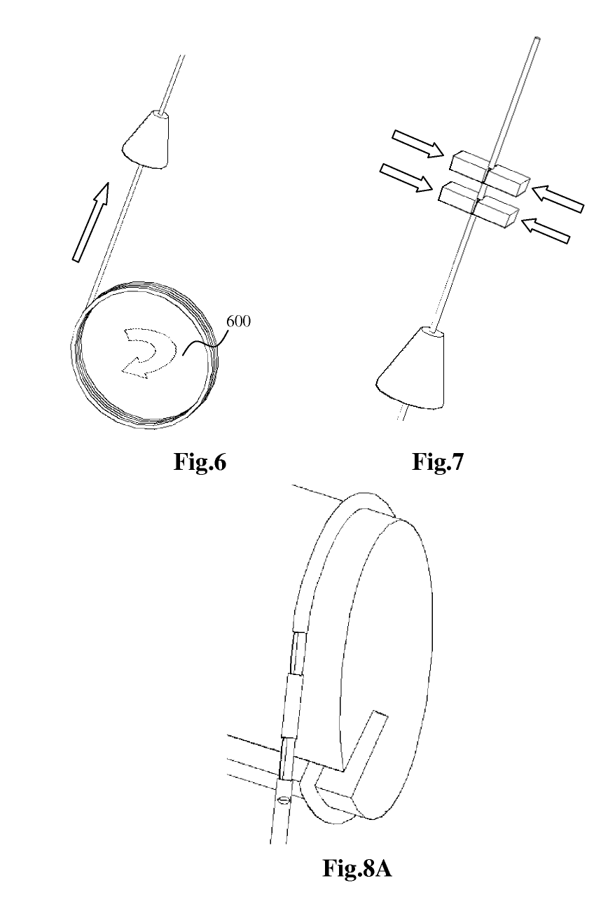

FIG. 5 shows a process flowchart of manufacturing an electrical connector according to an embodiment of the invention. As shown in FIG. 5, first at step 501, metal wires are extracted or pulled out from a metal wire coil. This step is shown in FIG. 6, wherein 600 is the metal wire coil, the rotation arrow in the middle shows the rotation direction of the metal wire coil, the arrow along the metal wire shows the feed direction of metal wire, and the hammer shape on metal wire is used to mark an electrical connection element yet to be formed. As described above, the metal wire in the metal wire coil 600 has smooth surface, and its cross section is a circle or an ellipse, for example. Furthermore, the metal wire has good elasticity and conductivity. In one embodiment, the metal wire also has high hardness and strength to bear large pressure. In a specific example, the metal wire is copper alloy. Further, surface of the metal wire may be coated with a stable coating, such as plating gold over nickel underplating on surface of copper alloy. It is appreciated that, those skilled in the art can choose appropriate metal material according to requirement on connection nature of the electrical connection element.

Next, in step 503, retention parts are formed at proper positions of metal wire. FIG. 7 shows a process of forming retention parts according to an embodiment of the invention. In the example of FIG. 7, two pairs of punch dies are used to clamp the metal wire and planish local part of the metal wire with pressure through plane portions of the punch dies, thereby forming the retention parts. Thus, the formed retention parts have a width larger than other positions in one dimension. Although in the example of FIG. 7, two retention parts are formed with two pairs of punch dies, it is appreciated that, based on the desired size of the electrical connection element, only one retention part may be formed or more than two retention parts may be formed at proper positions. Furthermore, using punch die to form retention part is just an example, and those skilled in the art can use other known die or method to form the retention part.

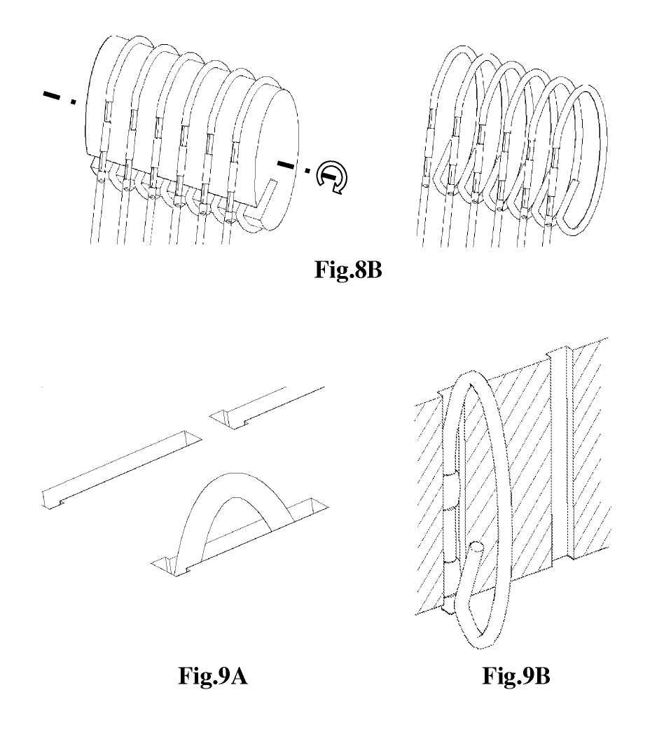

To fix the shape of metal wire, in step 505, the metal wire is shaped as an ellipse by rotating an elliptic die. FIG. 8A shows a process of shaping a metal wire according to an embodiment of the invention. As shown in FIG. 8A, one end of the metal wire is fixed to a die whose cross section is an ellipse and the die is rotated so that the metal wire is wound on surface of the die and subsequently forms the shape of an ellipse. In one embodiment, there may have a notch on the surface of the elliptic die for allowing the tail end of the metal wire inserted and fixed into the die. In other embodiments, one end of metal wire may also be fixed to the die through other manners such as meshing, adhesion etc so as to form a point of strength, such that the rotation of the die can form the metal wire into desired shape.

In one embodiment, multiple metal wires may be wound on a rotating die simultaneously so as to form a plurality of electrical connection elements at a time. FIG. 8B shows a process of shaping multiple metal wires according to an embodiment of the invention. During that process, multiple metal wires are simultaneously wound on a same elliptic die, and thus formed into an elliptic shape once at a time by rotating the die. Thereafter, the rotating die is taken out and a row of elliptic electrical connection elements are obtained.

After the shaped electrical connection element is obtained, in step 507, the electrical connection element is inserted into a slot of the housing of the electrical connector. Generally, a plurality of slots are arranged as an array in the housing of the electrical connector for receiving and fixing electrical connection elements. Therefore, the slot has a size and shape corresponding to the electrical connection element acquired at step 505. FIG. 9 shows the interaction of a slot of the electrical connector with a retention part according to an embodiment of the invention. In the embodiment shown in FIG. 9, the main body of the slot is a long strip with one end (referred to herein as first end) of the long strip having a width larger than that of the main body of the long strip. Such a slot shape corresponds to the electrical connection element that has retention parts at one side. Specifically, the width of the first end of the slot corresponds to the wider width of retention parts in the electrical connection element. Accordingly, during the process of inserting the electrical connection element into the slot, the wider width portion of the retention parts of the electrical connection element needs to be aligned with the width of the first end of the slot, and the short axis of the ellipse formed by the electrical connection element is made to be received in the slot along direction of main body of the slot. FIG. 9B shows interaction of retention parts with the slot in form of a local cutaway view. As shown, retention parts in the electrical connection element correspond to the width of the first end of the slot and are thus stuck in that first end. Thereby, wider width of the retention parts interacts with the housing of the electrical connector and functions to fix the electrical connection element. It is appreciated that, if setting and position of retention parts in the electrical connection element varies, then shape of the slot will also change accordingly. In one embodiment, after a row of electrical connection elements are acquired at a time, the electrical connection elements may also be simultaneously inserted into slots at a time.

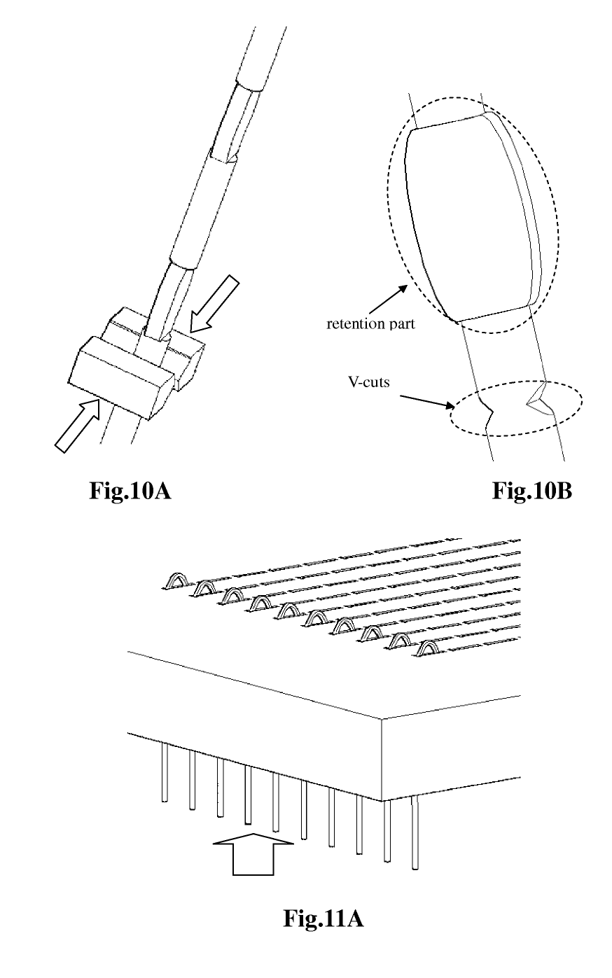

In one embodiment, before the electrical connection element is inserted into a slot at step 507, V-cuts may be formed at tail end of the electrical connection element. FIG. 10A shows a process of forming V-cuts according to an embodiment of the invention, and FIG. 10B shows the V-cuts formed according to the process of FIG. 10A. As shown in FIG. 10A, at tail end of the metal wire forming an electrical connection element there is provided a pair of punch dies which have a protrusion part at the side facing the metal wire. V-cuts are incised or notched in the metal wire through clamping and pressure of the pair of punch dies. The form of the V-cuts is shown in FIG. 10B. Depending on convenience in manufacture process, the V-cuts may be formed at any stage before step 507.

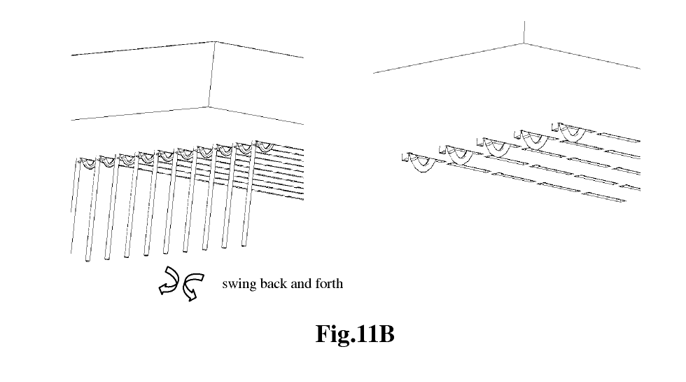

In case that V-cuts are formed, the electrical connection element will not be broken apart from subsequent metal wire until step 507. FIGS. 11A and 11B show a process of inserting electrical connection elements into slots and breaking the metal wires according to an embodiment of the invention. Specifically, in step 507, ‘tails’ of un-broken electrical connection elements may be used as support to assist in inserting the electrical connection elements into slots, as shown in FIG. 11A. Next, after the electrical connection elements have been fixed into the slots, the electrical connection elements are broken apart from subsequent metal wires by swinging the metal wires at the V-cuts back and forth. Such a process makes inserting and breaking of electrical connection elements very simple and easy to operate.

In other embodiments, tail end of metal wire of an electrical connection element may also be broken apart through other manners such as being sheared off or cut off directly by an instrument. Depending on convenience in operation, breaking of electrical connection element may be accomplished before or after being inserted into the housing of the electrical connector.

A process 501-507 of forming an electrical connector has been described above in conjunction with detailed embodiments. However, it is appreciated that, the above described step sequence is merely illustrative, and the process of forming an electrical connector is not necessarily performed in the order of steps 501-507. For example, in one embodiment, the step for forming retention parts may be performed after the shaping of the electrical connection element; in another embodiment, for example, retention parts may be formed by planishing metal wire with another die while rotating the elliptic die, so that retention parts are formed at the same time of forming shape of the electrical connection element.

It should be appreciated that, the terminology used herein is for the purpose of describing particular embodiments only and is not intended to be limiting of the invention. The singular forms “a”, “an” and “the” used in the invention are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications are suited to the particular use contemplated. The above various modifications, variations and embodiments should all fall within scope of the invention.

1. An electrical connection element made up of a metal wire that is an ellipse as a whole, two end portions of one axis of the ellipse forming an upper contact part and a lower contact part respectively, at least one retention part being formed at the middle part between the upper contact part and the lower contact part, and the retention part being wider than other positions of the electrical connection element in at least one dimension.

2. The electrical connection element of claim 1, wherein the metal wire is made from copper alloy.

3. The electrical connection element of claim 1, wherein surface of the metal wire is coated with gold over nickel underplating.

4. The electrical connection element of claim 1, wherein the at least one retention part is formed by planishing the metal wire.

5. The electrical connection element of claim 1, wherein the number of the at least one retention part is two.

6. The electrical connection element of claim 1, wherein tail end of the metal wire is formed by breaking the metal wire along V-cuts.

7. An electrical connector comprising:
a housing having at least one slot therein;
at least one electrical connection element of claim 1 disposed in the at least one slot, wherein the upper contact part of each electrical connection element extends above the upper surface of the housing, the lower contact part of each electrical connection element extends below the lower surface of the housing, and the at least one retention part is embedded in the at least one slot.

8. A method for manufacturing an electrical connection element, comprising:
forming at least one retention part on a metal wire, the metal wire where the retention part locates being wider than other positions in at least one dimension; and
shaping the metal wire into an ellipse as a whole to be used as an electrical connection element, two end portions of one axis of the ellipse forming an upper contact part and a lower contact part respectively.

9. The method of claim 8, wherein the metal wire is made from copper alloy.

10. The method of claim 8, wherein surface of the metal wire is coated with gold over nickel underplating.

11. The method of claim 8, wherein forming at least one retention part comprises planishing the metal wire with at least one pair of punch dies.

12. The method of claim 8, wherein forming at least one retention part comprises forming two retention parts.

13. The method of claim 8, wherein shaping the metal wire into an ellipse as a whole comprises: fixing one end of the metal wire onto a die whose cross section is an ellipse, and rotating the die such that the metal wire is wound on the surface of the die, thereby forming an ellipse.

14. The method of claim 13, wherein shaping the metal wire into an ellipse comprises:
winding multiple metal wires onto the die simultaneously to form ellipses at the same time.

15. The method of claim 8, further comprising forming V-cuts at tail end of the metal wire.

16. The method of claim 15, wherein forming V-cuts comprises notching the V-cuts on the metal wire with punch dies.

17. The method of claim 15, further comprising: breaking the metal wire by swinging the metal wire back and forth at the V-cuts.

18. A method for manufacturing an electrical connector, comprising:
manufacturing an electrical connection element according to the method of claim 8; and
inserting at least one electrical connection element into at least one slot of a housing, such that the upper contact part of each electrical connection element extends above the upper surface of the housing, the lower contact part of each electrical connection element extends below the lower surface of the housing, and the at least one retention part is embedded in the at least one slot.

19. The method of claim 18, wherein inserting at least one electrical connection element into at least one slot of a housing comprises inserting multiple electrical connection elements into multiple slots of the housing simultaneously.
